(19) United States
(12) Patent Application Publication
(10) Pub. No.: US 2026/0031333 A1
(43) Pub. Date: Jan. 29, 2026

(54) ULTRA-FAST CHARGEABLE AND LOW COST BATTERY CELLS FOR BATTERY ELECTRIC VEHICLES

(71) Applicant: GM GLOBAL TECHNOLOGY OPERATIONS LLC, Detroit, MI (US)

(72) Inventors: Dewen KONG, Shanghai (CN); Haijing LIU, Shanghai (CN); Fan XU, Oakland Township, MI (US); Mei CAI, Bloomfield Hills, MI (US)

(21) Appl. No.: 18/890,441

(22) Filed: Sep. 19, 2024

(30) Foreign Application Priority Data
Jul. 23, 2024 (CN) 202410993699X

(51) Int. Cl. H01M 4/36; H01M 4/02; H01M 4/38; H01M 4/58; H01M 4/62; H01M 4/66

(52) U.S. Cl. CPC H01M 4/366; H01M 4/386; H01M 4/5825; H01M 4/622; H01M 4/625; H01M 4/661; H01M 2004/021; H01M 2004/027

(57) ABSTRACT

A battery cell includes A anode electrodes including an anode active material layer and an anode current collector, S separators, and C capacitor-boosted cathode electrodes, where A, C, and S are integers greater than one. Each of the C capacitor-boosted cathode electrodes includes a cathode current collector; a capacitor layer arranged on the cathode current collector; and a cathode active material layer including cathode active material arranged on the capacitor layer.

### CROSS-REFERENCE TO RELATED APPLICATIONS

This application claims the benefit of Chinese Patent Application No. 202410993699.X, filed on Jul. 23, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to fast chargeable and low cost battery cells for battery electric vehicles and other applications.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer (including cathode active material) arranged on a cathode current collector. The anode electrodes include an anode active material layer (including anode active material) arranged on an anode current collector.

### SUMMARY

A battery cell includes A anode electrodes including an anode active material layer and an anode current collector, S separators, and C capacitor-boosted cathode electrodes, where A, C, and S are integers greater than one. Each of the C capacitor-boosted cathode electrodes includes a cathode current collector; a capacitor layer arranged on the cathode current collector; and a cathode active material layer including cathode active material arranged on the capacitor layer.

In other features, the cathode active material is selected from a group consisting of lithium iron phosphate (LFP), LiNiₓMn_{y}Co_{1-x-y}O₂, LiNiₓMn₁₋ₓO₂, Li₁₊ₓMO₂ (where 0<x<1, and 0<y<1), a spinel, an olivine, and combinations thereof. The cathode active material layer includes the cathode active material in a range from 90 wt % to 97.5 wt %, a conductive filler in a range from 0.5 wt % to 5 wt %, and a binder in a range from 2 wt % to 5 wt %.

In other features, loading of the cathode active material layer is in a range from 1.5 to 5 mAh/cm², and the porosity of the cathode active material layer is in a range from 20% to 50%. The cathode active material includes lithium iron phosphate (LFP) with a carbon coating. The capacitor layer includes a capacitor material in a range from 49 wt % to 97.5 wt %, a conductive filler in a range from 0.5 wt % to 45 wt %, and a binder in a range from 2 wt % to 6 wt %. The capacitor material is selected from a group consisting of carbon, graphene, carbon nanotubes (CNT), a metal oxide, a polymer, and combinations thereof. The porosity of the capacitor layer is in a range from 50% to 95%.

In other features, the anode active material layer includes graphite with an outer coating including a material selected from a group consisting of hard carbon, soft carbon, Li₄Ti₅O₁₂ (LTO), Li₅PO₄, a solid-state electrolyte, and combinations thereof. The anode active material layer includes a blend of graphite particles and silicon-based particles.

In other features, the silicon-based particles are selected from a group consisting of silicon oxide (SiOₓ), lithiated silicon oxide (LSO), silicon-carbon (Si—C), silicon (Si), Si alloy, and combinations thereof. The silicon-based particles comprise 5 wt % to 30 wt % of the anode active material layer.

A battery cell includes A anode electrodes including an anode current collector and an anode active material layer comprising graphite particles, S separators, and C capacitor-boosted cathode electrodes. Each of the C capacitor-boosted cathode electrodes includes a cathode current collector, a capacitor layer arranged on the cathode current collector, and a cathode active material layer arranged on the capacitor layer. The cathode active material layer includes lithium iron phosphate (LFP) and loading of the cathode active material layer is in a range from 1.5 to 5 mAh/cm².

In other features, the cathode active material layer includes the LFP in a range from 90 wt % to 97.5 wt %, a conductive filler in a range from 0.5 wt % to 5 wt %, and a binder in a range from 2 wt % to 5 wt %. The capacitor layer includes a capacitor material in a range from 89 wt % to 97.5 wt %, a conductive filler in a range from 0.5 wt % to 5 wt %, and a binder in a range from 2 wt % to 6 wt %. The capacitor material is selected from a group consisting of carbon, graphene, carbon nanotubes (CNT), a metal oxide, a polymer, and combinations thereof.

In other features, the graphite particles include an outer coating including a material selected from a group consisting of hard carbon, soft carbon, Li₄Ti₅O₁₂ (LTO), Li₅PO₄, a solid state electrolyte, and combinations thereof.

In other features, the anode active material layer includes a blend of the graphite particles and silicon-based particles. The silicon-based particles are selected from a group consisting of silicon oxide (SiOₓ), lithiated silicon oxide (LSO), silicon-carbon (Si—C), silicon (Si), Si alloy, and combinations thereof. The silicon-based particles comprise 5 wt % to 30 wt % of the anode active material layer.

A battery cell includes A anode electrodes including an anode active material layer arranged on an anode current collector, S separators, and C capacitor-boosted cathode electrodes. Each of the C capacitor-boosted cathode electrodes includes a cathode current collector, a capacitor layer arranged on the cathode current collector, and a cathode active material layer arranged on the capacitor layer. The anode active material layer includes a material selected from the group consisting of coated graphite particles, a blend of graphite particles and silicon-based particles, and combinations thereof.

In other features, the cathode active material is selected from a group consisting of lithium iron phosphate (LFP), LiNiₓMn_{y}Co_{1-x-y}O₂, LiNiₓMn₁₋ₓO₂, Li₁₊ₓMO₂ (where 0<x<1, and 0<y<1), a spinel, an olivine, and combinations thereof. Loading of the cathode active material layer is in a range from 1.5 to 5 mAh/cm². The cathode active material layer includes the LFP in a range from 90 wt % to 97.5 wt %, a conductive filler in a range from 0.5 wt % to 5 wt %, and a binder in a range from 2 wt % to 5 wt %.

In other features, the capacitor layer includes a capacitor material in a range from 89 wt % to 97.5 wt %, a conductive filler in a range from 0.5 wt % to 5 wt %, and a binder in a range from 2 wt % to 6 wt %. The capacitor material is selected from a group consisting of carbon, graphene, carbon nanotubes (CNT), a metal oxide, a polymer, and combinations thereof.

In other features, the silicon-based particles are selected from a group consisting of silicon oxide (SiOₓ), lithiated silicon oxide (LSO), silicon-carbon (Si—C), silicon (Si), Si alloy, and combinations thereof. The silicon-based particles comprise 5 wt % to 30 wt % of the anode active material layer.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell including C capacitor-boosted cathode electrodes, A anode electrodes, and S separators according to the present disclosure;

FIG. 2A is a side cross section of an example of one of the C capacitor-boosted cathode electrodes according to the present disclosure;

FIG. 2B is a side cross section of a cathode active material with an outer coating according to the present disclosure;

FIG. 2C is a side cross section of an example of one of the A anode electrodes according to the present disclosure;

FIG. 2D is a side cross section of an anode active material with an outer coating according to the present disclosure;

FIG. 3 is a graph showing an example of voltage as a function of areal capacity for the first example cathode electrode in half coin cell (vs Li metal) according to the present disclosure;

FIG. 4 is a graph showing an example of voltage and current as a function of capacity for the first example battery cell according to the present disclosure;

FIG. 5 is a graph showing an example of SOC and cell temperature as a function of time for during fast charging for the first example battery cell according to the present disclosure;

FIG. 6 includes graphs showing an example of charge rate as a function of cycles, capacity, and coulombic efficiency as a function of cycles, SOC as a function of time, and voltage as a function of SOC for a second example battery cell including capacitor-boosted cathode electrodes and an anode electrode with a blend of graphite and LSO particles according to the present disclosure; and

FIG. 7 includes graphs showing charge rate as a function of cycles, capacity, and coulombic efficiency as a function of cycles, SOC as a function of time, and voltage as a function of SOC for a second example battery cell including capacitor-boosted cathode electrodes and an anode electrode with a blend of graphite and Si—C particles according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Factors affecting widespread adoption of battery electric vehicles (BEVs) include charging time and price. Reducing charging time and price will ease customer concerns and increase adoption of BEVs.

Battery cells according to the present disclosure are ultra-fast chargeable (e.g., at charging rates greater than 6C) and relatively low-cost. The battery cells for BEVs are enabled by capacitor-boosted cathode electrodes and dedicated fast charge anode electrodes. The capacitor-boosted cathode electrodes include a cathode active material layer (e.g., LFP), a capacitor layer (e.g., activated carbon), and a cathode current collector. In some examples, the charge rate is tuned by adjusting the relative thicknesses of the capacitor layer and the cathode active material layer.

In some examples, the dedicated fast charge anode electrode includes surface-modified artificial graphite or a blend of graphite particles and silicon-based particles. The battery cells enable ultrafast fast charging at lower cost while maintaining relatively high energy density (e.g., 0% SOC to 80% SOC in 8 mins with >330 Wh/L). The battery cell can be manufactured in various formats including stacked, winding, and cylindrical using existing lithium-ion battery lines and manufacturing processes.

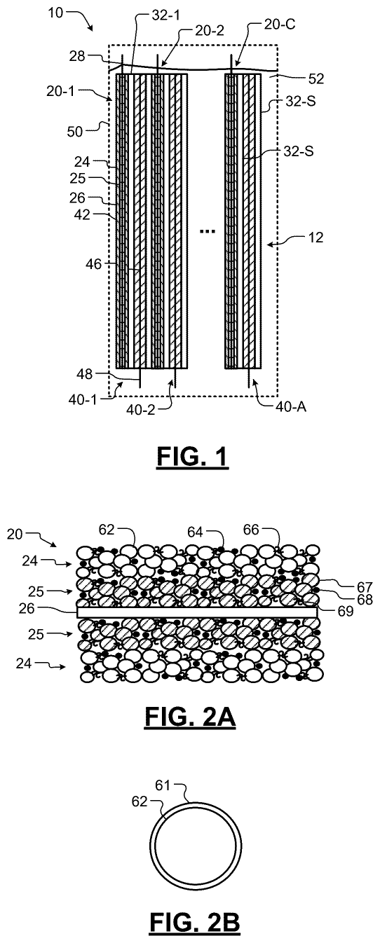

Referring now to FIG. 1, a battery cell 10 includes C capacitor-boosted cathode electrodes 20, A anode electrodes 40, and S separators 32 arranged in a predetermined sequence in a battery cell stack 12, where C, S and A are integers greater than zero. The battery cell stack 12 is arranged in an enclosure 50. Liquid electrolyte 52 is added to the enclosure 50.

The C capacitor-boosted cathode electrodes 20-1, 20-2, . . . , and 20-C include a cathode active material layer 24 arranged on one or both sides of a capacitor layer 25. The capacitor layer 25 is arranged on one or both sides of a cathode current collector 26.

The A anode electrodes 40-1, 40-2, . . . , and 40-A include an anode active material layer 42 arranged on one or both sides of the anode current collectors 46. The S separators 32-1, 32-2, . . . , and 32-S are arranged between the C capacitor-boosted cathode electrodes 20 and the A anode electrodes 40.

In some examples, the A anode electrodes 40 and the C capacitor-boosted cathode electrodes 20 exchange lithium ions during charging/discharging. In some examples, the cathode active material layers 24, the capacitor layer 25, and/or the anode active material layers 42 comprise coatings including one or more active materials or capacitor materials, one or more conductive additives, and/or one or more binder materials that are cast or applied onto a surface. For example, the capacitor layer 25 can be cast or applied onto the cathode current collector 26 and the cathode active material layer 24 is cast or applied onto the capacitor layer 25.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

Referring now to FIGS. 2A to 2D, examples of the electrodes are shown. In FIG. 2A, one of the C capacitor-boosted cathode electrodes 20 is shown in more detail. The cathode active material layer 24 includes a cathode active material 62, a conductive additive 64, and a binder 66. The capacitor layer 25 includes a capacitor material 67, a conductive additive 68, and a binder 69.

In some examples, the cathode active material layer includes the cathode active material 62 in a range from 90 wt % to 97.5 wt %, the conductive additive 64 in a range from 0.5 wt % to 5 wt %, and the binder 66 in a range from 2 wt % to 5 wt %. In some examples, the cathode active material 62 includes lithium iron phosphate (LFP). In some examples, a primary particle size of the cathode active material 62 is in a range from 0.1 μm to 1 μm. In some examples, the cathode active material 62 includes a carbon coating 61 as shown in FIG. 2B. In some examples, the carbon coating comprises in a range from 0.9% to 2 wt. % of the cathode active material 62. In other examples, the cathode active material is selected from a group consisting of LiNiₓMn_{y}Co_{1-x-y}O₂, LiNiₓMn₁₋ₓO₂, Li₁₊ₓMO₂ (e.g., NMC111, NMC523, NMC622, NMC721, etc.) (where 0<x<1, and 0<y<1), a spinel (e.g., LiMn₂O₄), an olivine (e.g., LMFP), and combinations thereof.

In some examples, the conductive additive 64 includes a carbon-based additive. In some examples, the carbon additive is selected from a group consisting of Super P, KS-6, graphite, graphene nano plates, single walled carbon nanotubes (SWCNT), multi-walled carbon nanotubes (MWCNT), and combinations thereof. In some examples, the binder 66 includes a non-aqueous solvent and/or a polymer such as polyvinylidene difluoride (PVDF), polytetrafluoroethylene (PTFE), polyvinylidene difluoride hexafluoropropylene (PVDF-HFP), and combinations thereof.

In some examples, loading of the cathode active material layer 24 is in a range from 1.5 to 5 mAh/cm². In some examples, loading of the cathode active material layer 24 is in a range from 1.7 to 3.5 mAh/cm². In some examples, the press density of the cathode active material layer 24 is in a range from 1.5 to 3.6 g/cc. In some examples, the press density of the cathode active material layer 24 is in a range from 2.4 to 2.7 g/cc. In some examples, the porosity of the cathode active material layer 24 is in a range from 20%-50%. In some examples, the porosity of the cathode active material layer is in a range from 25% to 35%.

In some examples, the capacitor material 67 is in a range from 49 wt % to 97.5 wt %, the conductive filler is in a range from 0.5 wt % to 45 wt % and the binder is in a range from 2 wt % to 6 wt %. In some examples, the capacitor material 67 is selected from a group consisting of carbon (e.g., activated carbon), graphene, carbon nanotubes (CNT), metal oxides (e.g., MOₓ (where M=Co, Ru, Nb)), polymers (e.g., polyaniline, polyacetylene, or other suitable polymers), and combinations thereof.

In some examples, the capacitor material 67 has a single-sided thickness in a range from 1 μm to 50 μm. In some examples, the capacitor material 67 has a single-sided thickness in a range from 2 μm to 15 μm. In some examples, the press density of the capacitor material 67 is in a range from 0.3 to 0.7 g/cc. In some examples, the press density of the capacitor material 67 is in a range from 0.4 to 0.6 g/cc. In some examples, the porosity of the capacitor material 67 is in a range from 50% to 95%. In some examples, the porosity of the capacitor material 67 is in a range from 65% to 80%.

In FIG. 2C, one of the A anode electrodes 40 is shown in more detail. The anode active material layer 42 includes an anode active material 72, a conductive additive 74, and a binder 76. In some examples, the anode active material layer 42 includes the anode active material 72 in a range from 90 wt % to 97.7 wt %, the conductive additive 74 in a range from 0.3 wt % to 4 wt %, and the binder 76 in a range from 2 wt % to 6 wt %.

In some examples, the anode active material 72 includes graphite particles with a coating 71 (e.g., surface modified artificial graphite) as shown in FIG. 2D. In some examples, the coating 71 is selected from a group consisting of hard carbon, soft carbon, Li₄Ti₅O₁₂ (LTO), Li₃PO₄, a solid-state electrolyte (e.g., Li_{1.4}Al_{0.4}Ti_{1.6}(PO₄)₃ LATP, Li₇La₃Zr₇O₁₂ (LLZO)), and combinations thereof.

In some examples, the anode active material includes a blend of graphite particles and a silicon-based particles selected from a group consisting of silicon oxide (SiOₓ), lithiated silicon oxide (LSO), silicon-carbon (Si—C), silicon (Si), Si alloy, and combinations thereof. In some examples, the silicon-based particles comprise 5 wt % to 30 wt % of the anode active material layer. In some examples, a D50 particle size of the graphite particles is in a range from 6 μm to 20 μm. In some examples, Brunauer, Emmett and Teller (BET) is in a range from 1 m²/g to 10 m²/g. In some examples, graphite comprises 70 wt % to 90 wt %. In some examples, press density is in a range from 0.5 g/cc to 1.5 g/cc.

In some examples, the anode active material 72 includes a blend of graphite particles and lithiated silicon oxide (LSO) Li_{y}SiOₓ particles (where 0<x<2, 0<y<1). In some examples, a D50 particle size of the LSO (or other silicon-based particles) is in a range from 3 μm to 20 μm. In some examples, BET is in a range from 0.5 m² to 10 m². In some examples, press density is in a range from 0.8 g/cc to 1.5 g/cc.

In some examples, the anode active material 72 includes a blend of graphite particles and silicon-carbon (Si—C) particles. In some examples, a D50 particle size of the graphite particles is in a range from 3 μm to 20 μm. In some examples, BET is in a range from 0.5 m²/g to 10 m²/g. In some examples, press density is in a range from 0.6 g/cc to 1.5 g/cc. In some examples, Si content in the Si—C is in a range from 30% to 60 wt %.

In some examples, the conductive additive 74 is selected from a group consisting of Super P, graphite, graphene nano plates, SWCNT, MWCNT, and combinations thereof. In some examples, the binder 69 is selected from a group consisting of styrene butadiene rubber (SBR), carboxymethyl cellulose (CMC), polyacrylic acid (PAA), poly(sodium acrylate) (NaPAA), poly(lithium acrylate) (LiPAA), and combinations thereof.

In some examples, the loading of the anode electrode is in a range from 1.65 to 5.5 mAh/cm². In some examples, the loading of the anode electrodes is in a range from 1.87 to 3.85 mAh/cm². In some examples, the press density of the anode electrodes is in a range from 1.3 to 2 g/cc. In some examples, the press density of the anode electrodes is in a range from 1.5 to 1.7 g/cc. In some examples, the porosity of the anode active material layer is in a range from 20% to 50%. In some examples, the porosity of the anode active material layer is in a range from 20% to 35%.

In some examples, the S separators have a thickness in a range from 5 μm to 30 μm and a porosity in a range from 35% to 55%. In some examples, the separator includes a coating layer include a material selected from a group consisting of ceramic, polymer, and combinations thereof.

When the separator is coated, the separator can be double-sided coated separator with the same or different coating layers. Examples of double-sided coated separators include polymer layer/separator/polymer layer, polymer and ceramic layer/separator/polymer and ceramic layer, polymer layer/ceramic layer/separator/ceramic layer/polymer layer, polymer layer/separator/polymer and ceramic layer; polymer/separator/ceramic layer/polymer layer. Examples of single-sided separators include polymer layer/separator; polymer and ceramic layer/separator, or polymer layer/ceramic layer/separator. In some examples, the thickness of polymer coated layer is in a range from 1 μm to 5 μm. In some examples, the thickness of polymer coated layer is in a range from 1 μm to 3 μm.

In some examples, the electrolyte comprises lithium salt (e.g., LiPF₆, 0.8-1.2 mol/L), a solvent (e.g., carbonate ester), and an additive (e.g., fluoroethylene carbonate (FEC), vinylene carbonate (VC), 1,3,2-dioxathiolane 2,2-dioxide (DTD), tris (trimethylsilyl)phosphite (TMSPi), lithium bis(oxalate) borate (LiBOB), lithium bis(fluorosulfonyl)imide (LiFSI), lithium difluoro (oxalato) borate (Li DFOB), 3-(trimethylsilyl)phenylboronic acid (TMSPB), and combinations thereof).

In some examples, a voltage range of the battery cells is in a range from 2 to 4.5V. In some examples, an electrode capacity (N/P) ratio is in a range from 1 to 1.2. In some examples, the battery cells are stacked or wound. In some examples, a format of the battery is selected from a group consisting of pouch, prismatic, and cylindrical.

### Example 1

The cathode electrodes include a cathode active material layer including LFP/SP/CNT/PVDF with mass ratios of 95.4/2/0.1/2.5. The capacitor material layer includes AC/SP/PVDF with mass ratios of 92/3/5. Loading of the cathode active material layer is 3.0 mAh/cm². Loading of the capacitor material layer is 0.17 mAh/cm².

The anode electrodes include an anode active material layer including graphite/SP/CNT/SBR/CMC with mass ratios of 95.2/0.5/0.1/2.7/1.5. Loading of the anode active material layer is 3.3 mAh/cm². Press density of the anode active material layer is 1.5 to 1.6 g/cc. The N/P ratio is 1.1. The electrolyte includes 1M LiPF₆, ethylene carbonate (EC)/ethyl methyl carbonate (EMC) 3/7 by volume, 1 wt % VC, and 0.5 wt % DTD. The separators have a thickness of 13 μm and a porosity of 48%. The separator include a 1 μm boehmite layer, 9 μm PE layer, and a 1 μm boehmite layer. Formation was performed at 25° C. and C/20.

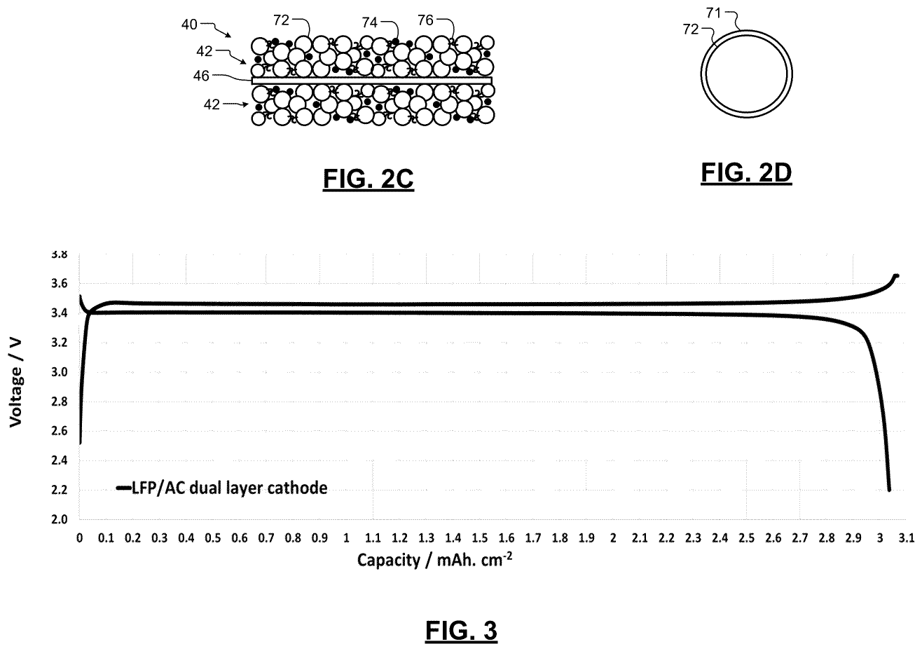

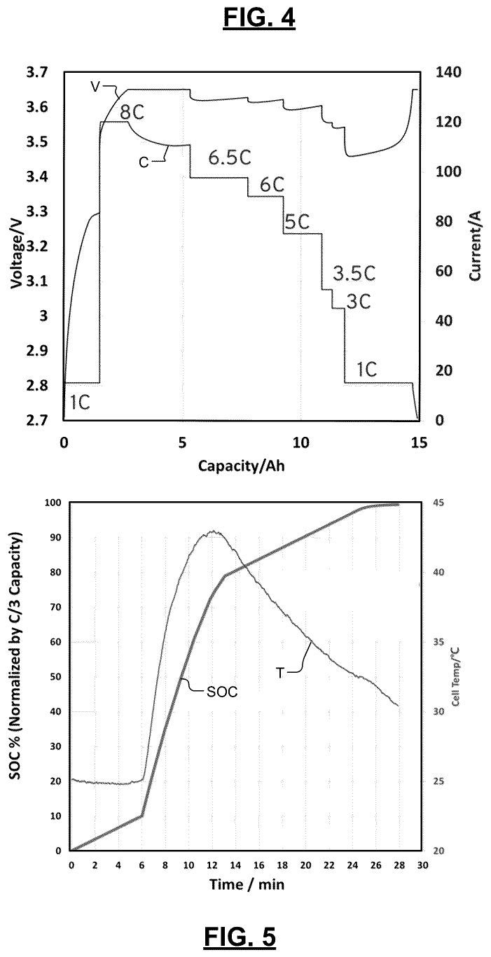

Referring now to FIGS. 3 to 5, performance of the battery cell of Example 1 is shown. In FIG. 3, voltage is shown as a function of capacity during a first cycle at 0.05C/0.05C at 25° C. In FIG. 4, performance of the battery cell is shown during DC fast charging. In FIG. 5, the temperature of the battery cell rose about 18° C. during DC fast charging from a 10% state of charge (SOC) to 80% SOC in a period of about 7 minutes.

### Example 2

The cathode electrodes of the second example battery cell include a cathode active material layer including LFP/SP/CNT/PVDF with mass ratios of 95.4/2/0.1/2.5. The capacitor material layer includes AC/SP/PVDF with mass ratios of 92/3/5. Loading of the cathode active material layer is 3.0 mAh/cm². Loading of the capacitor material layer is 0.17 mAh/cm².

The anode electrode includes an anode active material layer including graphite/Si/SP/SWCNT/PAA/SBR/CMC with mass ratios of 85.5/9.45/0.5/0.1/1.7/1.4/1.8, respectively. The Si includes LSO or Si—C particles. Loading of the anode active material layer is 3.3 mAh/cm². Press density of the anode active material layer is 1.5 to 1.6 g/cc. the N/P ratio is 1.1. The electrolyte includes 1M LiPF₆, EC/EMC at a ratio of 3/7 by volume, 1 wt % VC, 0.5 wt % DTD, and 2 wt % FEC. The separator has a thickness of 13 μm and a porosity of 48%. The separator includes a 1 μm boehmite layer, 9 μm polyethylene (PE) layer, and a 1 μm boehmite layer. Formation was performed at 25° C. and C/20.

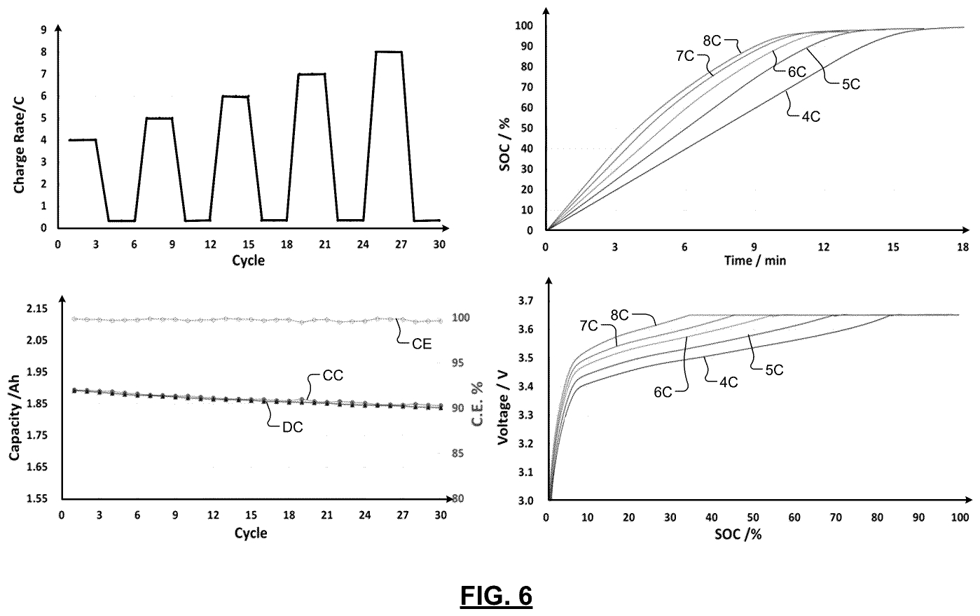

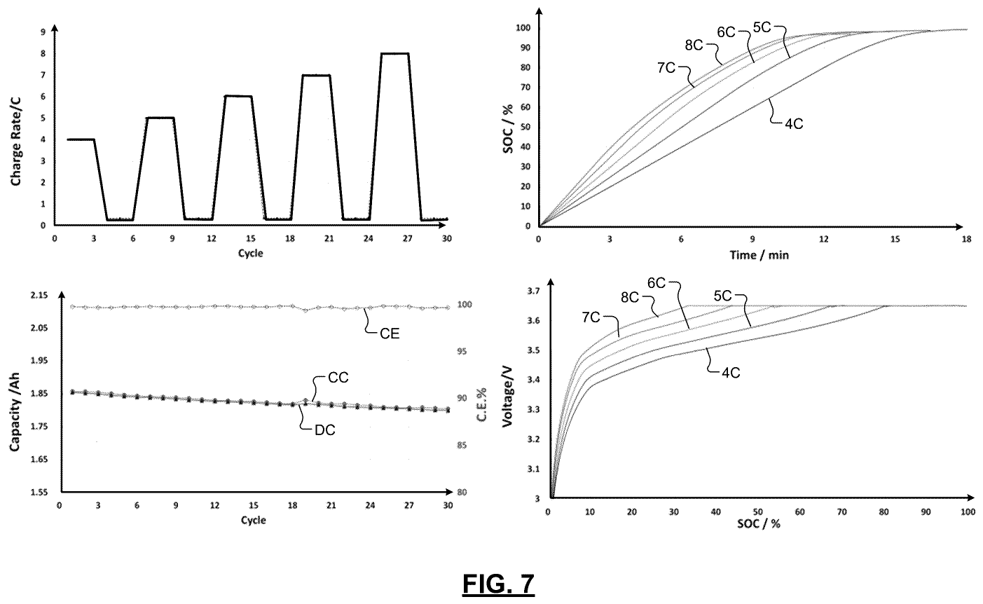

Referring now to FIGS. 6 and 7, charge rate, capacity, SOC, and voltage graphs illustrate performance of battery cells including a blend of graphite and 10 wt % LSO particles (Example 2-FIG. 6) and a blend of graphite and 10 wt % SiC particles (modified Example 2-FIG. 7). The battery cells demonstrated DC fast charging from 10% SOC to 80% SOC with high coulombic efficiency (CE) and little capacity degradation from 4C to 8C. For the battery cell in FIG. 6, charging was performed within 12 minutes at a rate of 40, 10 minutes at a rate of 50, 8.5 minutes at a rate of 6C, 8.5 minutes at a rate of 7C, and 7.4 minutes at a rate of 8C.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery cell, comprising:
A anode electrodes including an anode active material layer and an anode current collector;
S separators; and
C capacitor-boosted cathode electrodes, where A, C, and S are integers greater than one,
wherein each of the C capacitor-boosted cathode electrodes includes:
a cathode current collector;
a capacitor layer arranged on the cathode current collector; and
a cathode active material layer including cathode active material arranged on the capacitor layer.

2. The battery cell of claim 1, wherein:
the cathode active material is selected from a group consisting of lithium iron phosphate (LFP), LiNiₓMn_{y}Co_{1-x-y}O₂, LiNiₓMn₁₋ₓO₂, Li₁₊ₓMO₂ (where 0<x<1, and 0<y<1), a spinel, an olivine, and combinations thereof, and
the cathode active material layer includes the cathode active material in a range from 90 wt % to 97.5 wt %, a conductive filler in a range from 0.5 wt % to 5 wt %, and a binder in a range from 2 wt % to 5 wt %.

3. The battery cell of claim 1, wherein:
loading of the cathode active material layer is in a range from 1.5 to 5 mAh/cm², and
the porosity of the cathode active material layer is in a range from 20% to 50%.

4. The battery cell of claim 1, wherein the cathode active material includes lithium iron phosphate (LFP) with a carbon coating.

5. The battery cell of claim 1, wherein the capacitor layer includes a capacitor material in a range from 49 wt % to 97.5 wt %, a conductive filler in a range from 0.5 wt % to 45 wt %, and a binder in a range from 2 wt % to 6 wt %.

6. The battery cell of claim 5, the capacitor material is selected from a group consisting of carbon, graphene, carbon nanotubes (CNT), a metal oxide, a polymer, and combinations thereof.

7. The battery cell of claim 1, wherein the porosity of the capacitor layer is in a range from 50% to 95%.

8. The battery cell of claim 1, wherein the anode active material layer includes graphite with an outer coating including a material selected from a group consisting of hard carbon, soft carbon, Li4Ti5O12 (LTO), Li3PO4, a solid-state electrolyte, and combinations thereof.

9. The battery cell of claim 1, wherein the anode active material layer includes a blend of graphite particles and silicon-based particles.

10. The battery cell of claim 9, wherein:
the silicon-based particles are selected from a group consisting of silicon oxide (SiOₓ), lithiated silicon oxide (LSO), silicon-carbon (Si—C), silicon (Si), Si alloy, and combinations thereof; and
the silicon-based particles comprises 5 wt % to 30 wt % of the anode active material layer.

11. A battery cell, comprising:
A anode electrodes including an anode current collector and an anode active material layer comprising graphite particles;
S separators; and
C capacitor-boosted cathode electrodes,
each of the C capacitor-boosted cathode electrodes includes:
a cathode current collector;
a capacitor layer arranged on the cathode current collector; and
a cathode active material layer arranged on the capacitor layer,
wherein the cathode active material layer includes lithium iron phosphate (LFP), and
wherein loading of the cathode active material layer is in a range from 1.5 to 5 mAh/cm².

12. The battery cell of claim 11, wherein the cathode active material layer includes the LFP in a range from 90 wt % to 97.5 wt %, a conductive filler in a range from 0.5 wt % to 5 wt %, and a binder in a range from 2 wt % to 5 wt %.

13. The battery cell of claim 11, wherein:
the capacitor layer includes a capacitor material in a range from 89 wt % to 97.5 wt %, a conductive filler in a range from 0.5 wt % to 5 wt %, and a binder in a range from 2 wt % to 6 wt %, and
the capacitor material is selected from a group consisting of carbon, graphene, carbon nanotubes (CNT), a metal oxide, a polymer, and combinations thereof.

14. The battery cell of claim 11, wherein the graphite particles include an outer coating including a material selected from a group consisting of hard carbon, soft carbon, Li₄Ti₅O₁₂ (LTO), Li₃PO₄, a solid state electrolyte, and combinations thereof.

15. The battery cell of claim 11, wherein:
the anode active material layer includes a blend of the graphite particles and silicon-based particles,
the silicon-based particles are selected from a group consisting of silicon oxide (SiOₓ), lithiated silicon oxide (LSO), silicon-carbon (Si—C), silicon (Si), Si alloy, and combinations thereof, and
the silicon-based particles comprise 5 wt % to 30 wt % of the anode active material layer.

16. A battery cell, comprising:
A anode electrodes including an anode active material layer arranged on an anode current collector;
S separators; and
C capacitor-boosted cathode electrodes,
each of the C capacitor-boosted cathode electrodes includes a cathode current collector, a capacitor layer arranged on the cathode current collector, and a cathode active material layer arranged on the capacitor layer,
the anode active material layer includes a material selected from the group consisting of coated graphite particles, a blend of graphite particles and silicon-based particles, and combinations thereof.

17. The battery cell of claim 16, wherein:
the cathode active material is selected from a group consisting of lithium iron phosphate (LFP), LiNixMnyCo1-x-yO2, LiNixMn1-xO2, Li1+xMO2 (where 0<x<1, and 0<y<1), a spinel, an olivine, and combinations thereof,
loading of the cathode active material layer is in a range from 1.5 to 5 mAh/cm², and
the cathode active material layer includes the LFP in a range from 90 wt % to 97.5 wt %, a conductive filler in a range from 0.5 wt % to 5 wt %, and a binder in a range from 2 wt % to 5 wt %.

18. The battery cell of claim 16, wherein:
the capacitor layer includes a capacitor material in a range from 89 wt % to 97.5 wt %, a conductive filler in a range from 0.5 wt % to 5 wt %, and a binder in a range from 2 wt % to 6 wt %, and
the capacitor material is selected from a group consisting of carbon, graphene, carbon nanotubes (CNT), a metal oxide, a polymer, and combinations thereof.

19. The battery cell of claim 16, wherein:
the silicon-based particles are selected from a group consisting of silicon oxide (SiOₓ), lithiated silicon oxide (LSO), silicon-carbon (Si—C), silicon (Si), Si alloy, and combinations thereof, and
the silicon-based particles comprise 5 wt % to 30 wt % of the anode active material layer.
